(19) United States
(12) Patent Application Publication
(10) Pub. No.: US 2004/0144304 A1
(43) Pub. Date: Jul. 29, 2004

(54) Rod for coating machine and method for producing the same

(75) Inventors: Atsushi Ooshima, Yoshida-Cho (JP); Satoru Matsumoto, Yoshida-Cho (JP); Kiyoshi Kamitani, Yoshida-Cho (JP)

Correspondence Address: YOUNG & THOMPSON, 745 SOUTH 23RD STREET 2ND FLOOR, ARLINGTON, VA, 22202

(73) Assignee: FUJI PHOTO FILM CO., LTD., MINAMI-ASHIGARA-SHI (JP)

(21) Appl. No.: 10/756,499

(22) Filed: Jan. 14, 2004

(30) Foreign Application Priority Data
Jan. 17, 2003 (JP) 2003-009271
Feb. 21, 2003 (JP) 2003-043937
Mar. 6, 2003 (JP) 2003-059470

(51) Int. Cl. B05D 1/12; B05C 1/00

(52) U.S. Cl. 118/208; 118/244; 427/180

(57) ABSTRACT

A rod for a coating machine according to the present invention includes a cylindrical base material, an intermediate layer formed on the surface of the base material and subjected to a lapping process and an abrasion-resistant film formed on the surface of the intermediate layer and subjected to a lapping process. The intermediate layer is a diffusion layer formed by reforming the surface of the base material by a diffusion process. Specifically, since the intermediate layer forms a part of the base material, the intermediate layer is firmly fixed to the base material and is not likely to separate from the base material. According to the present invention, a rod for a coating machine with high durability and a method for producing it are provided, which rod prevent flaws from developing on the surface of a base material object on which a coating solution is applied.

### CROSS-REFERENCE TO RELATED APPLICATION

This application claims priority under 35 USC 119 from Japanese Patent Applications Nos. 2003-9271, 2003-43937, 2003-59470, the disclosures of which are incorporated by reference herein.

### BACKGROUND OF THE INVENTION

1. Field of the Invention

The present invention relates to a rod for a coating machine on the surface of which an abrasion-resistant film is formed and a production method for the rod. More particularly, the invention relates to a rod for a coating machine optimum for applying a coating solution on a base material object such as a continuously travelling web or the like and a method for producing the rod for a coating machine.

2. Description of the Related Art

When a photosensitive material, a photolithography material, a magnetic recording material, a recording sheet material, a photosensitive lithographic printing plate, etc. are produced, a method has been widely adopted in which, while a sheet-shaped or web-shaped member made of a thin metallic plate, paper, a film or the like on which a coating solution is to be applied (referred to hereinafter as a base material object) is continuously moved in the longitudinal direction, the coating solution (photosensitive solution) is applied along the single surface thereof.

When the coating solution is applied to the surface of the base material object, a rod (bar) for a coating machine is generally positioned to abut on the surface of the base material object. Then, while the coating solution is applied to the surface of the rod, the rod for a coating machine is rotated to apply the coating solution on the surface of the base material object. This application method is referred to as a bar application method.

The rod for a coating machine is formed as a round rod with a circular sectional shape, a round rod on the surface of which grooves are formed along the circumferencial direction thereof or a round rod having a wire wound thereon. On the surface of the rod for a coating machine, a surface reforming treatment is generally performed to form an abrasion-resistant film. The film may be formed by various kinds of methods such as plating, a physical deposition, a chemical deposition, etc.

When protruding parts or recessed parts, that is, irregularities are formed on the surface of the rod for a coating machine, undesirable flaws (mainly, scratches) develop on the surface of the base material object on which the coating solution is applied. Accordingly, a lapping process is performed on the surface of the base material of the rod to produce a smooth surface, and an abrasion-resistant film is formed thereon by a surface reforming treatment.

However, a first problem with a conventional rod for a coating machine is that, even when the surface of the base material of the rod has undergone an adequate lapping process as described above, flaws still frequently occur on the coated surface of the base material object on which the coating solution has been applied.

For this reason, attempts at a solution have been made as described below. That is, an intermediate layer has been provided between the base material of the rod and the film to prevent the film from peeling off and to prevent flaws from developing on the surface of the base material object on which the coating solution is applied (for instance, see Patent Documents 1 and 2, that is, JP-A Nos. 6-64087 and 12-354808).

However, Patent Document 1 discloses an example where, in order to prevent separation of the film, a reduction in adhesion between a steel sheet plated with molten zinc and a synthetic resin intermediate layer was inhibited. In this case, however, the problem described above can not be completely solved. Further, Patent Document 2 discloses an example where, in order to prevent cracks or peeling-off from occurring on the film, even in circumstances where a strong impact is exerted on a rod for a coating machine, an intermediate layer is provided so that the hardness of a film gradually decreases in a downwards direction starting from an uppermost layer as far as a lowermost layer. However, like in the case of Patent Document 1, this example cannot solve the problem described above.

Further, a second problem with the conventional rod for a coating machine occurs, especially when a coating solution is applied to an anodic oxidation aluminum web at a high speed. In this case, there was an undesirable effect that the abrasion-resistant film formed on the surface of the rod became worn or separated within a short period, and thus the coating accuracy of the rod deteriorated.

Further, a third problem with the conventional rod for a coating machine is that, when a film is formed on the rod, micro cracks (chipping) tend to be developed on the film. This problem constitutes an obstacle to improving productivity in the production of a rod for a coating machine.

The prior arts proposed for overcoming the second and third problems are disclosed in JP-A Nos. 2000-901,2000-343012, 2000-354808, 2000-334349 and 4-048956 (referred to hereinafter respectively as Patent Document 3, Patent Document 4, Patent Document 5, Patent Document 6 and Patent Document 7).

Patent Document 3 discloses an example where, in order to form a hard chromium plated film or an amorphous chromium plated film, the maximum roughness of a film is set at 0.8 μm or less, and the thickness of the film is within a range of 1.5 μm to 30 μm. However, in this example, it is assumed that when the thickness of the film is increased, the film will peel off more easily.

Still further, the Patent Document 3 does not disclose a hardness of the film, and thus a further improvement needs to be made to slow down the speed at which the film is worn out.

Patent Document 4 discloses the ratio of the thickness of a ceramic film or a diamond film formed, in relation to the width of a flat surface of a protruding portion on the surface of a rod for a coating machine. However, in the example disclosed in this Document, it would have been desirable if the thickness of the film had been determined without the width of the flat surface being taken into consideration.

Patent Document 5 discloses an example wherein a film is composed of a plurality of layers and an intermediate layer is formed to make it difficult for the film to peel off. However, no concrete measure was provided to make it difficult for the intermediate film to peel off. Further, in this example, it would have been desirable if performance evaluation of the film had been confined to one single layer.

Patent Document 6 discloses an example where a ceramic film or a diamond film is formed on the surface of a base material of a rod as a film, grooves are formed in the base material and the radius of curvature of each of the protruding parts formed by the grooves is prescribed. Furthermore, in Patent Document 6, the radius of curvature of an end part of the protruding part formed by the grooves in the axial direction of the rod is prescribed in relation to the thickness of the film. However, since an amount of work required for cutting the protruding parts is considerable large, it is envisaged that the cutting work would require considerable time.

Further, in Patent Document 6, no consideration is given to the film, so that there is room for further improvement in slowing down the speed at which the film is worn out.

Further, Patent Document 7 discloses an example where in order to improve an abrasion-performance, a titanium nitride film is formed as an abrasion-proof film either directly on the surface of a rod or by way of an intermediate layer. However, since a hard chromium film is formed as the intermediate layer by plating, and the thickness of the titanium nitride layer as the film is not disclosed, it is suspected that the peeling-off of the intermediate layer will occur.

The inventor of the present invention has tried to solve the above-described problems by smoothing the surface of the base material of the rod with a higher degree of accuracy, but the problems were not solved by such attempts.

Thus, the inventor of the present invention analyzed the state of the surface of the film formed on the surface of the base material which film had been smoothed with high accuracy. As a result, the inventor discovered that micro protruding and recessed parts or irregularities had possibly developed on the surface of the film, and accordingly, that flaws (mainly, scratches) had occurred on the surface of the base material object on which coating solution was applied when a rod for a coating machine was used. Further, the inventor discovered that, concomitantly with the use of the rod for a coating machine, the number of protruding and recessed portions of the film decreased. However, the inventor also discovered that because of the presence of these protruding and recessed parts during an initial stage of use of the rod for the coating machine, flaws occurring on the surface of the base material object on which the coating solution was applied were deep.

The inventor further realized that, when a film having a high hardness and a high abrasion-resistant property is used, use of the rod for the coating machine does not result in elimination of the protruding and recessed parts. The inventor rather discovered, in this case, that the flaws tend to be formed over a long period on the surface of the base material object to which the coating solution is applied.

In accordance with the results of the research described above, the inventor of the invention hit upon the idea that, as a method of preventing the flaws from being formed on the surface of the base material object on which the coating solution is applied, a lapping process be performed on the surface of the film.

Further, the inventor of the present invention discovered that micro protruding parts developed on the surface of any one or more of the intermediate layers. From the viewpoint of abrasion-resistant characteristics, the film located on an uppermost surface generally has a high hardness and the thickness of the film cannot be increased to prevent chipping. Accordingly, protruding parts tend to be formed on the film due to the protruding parts which have been formed on the intermediate layer. The inventor discovered that, because of this, when the coating solution was applied to the base material object with the use of a rod for a coating machine, scratches tended to occur on the surface of the base material object on which the coating solution was applied.

Thus, the inventor of the present invention also hit upon the idea of a lapping process being carried out on the surface of the intermediate layer as a method for preventing the flaws from occurring on the surface of the base material object on which the coating solution is applied.

Further, the inventor of the present invention discovered that chipping of film frequently occurred as a result of the peeling-off of the intermediate layer. Thus, the inventor contrived a method to make it difficult fur the intermediate layer to peel off from the base material of the rod, and by carrying out experiments and studies arrived at a conclusion of the present invention.

### SUMMARY OF THE INVENTION

With the above-described circumstances taken into consideration, it is an object of the present invention to provide a rod for a coating machine with high durability and a method for producing the same, in the case of using which rod flaws are prevented from occurring on a surface of a base material object on which an coating solution is applied, and the development of cracks and peeling-off is prevented on a film formed on the surface of the rod.

According to a first aspect of the invention, a rod for a coating machine comprises a cylindrical base material, an intermediate layer formed on the surface of the base material and an abrasion-resistant film formed on the surface of the intermediate layer. The intermediate layer is a diffusion layer formed by reforming the surface of the base material by means of a diffusion process.

The thickness of the intermediate layer (diffusion layer) and the film is preferably 0.2 μm or more. When the thickness of the film is less than 0.2 μm, the thickness is not sufficient for the film to prevent abrasion. Further, the surface of the film becomes rough due to the roughness of the surface of the rod so that it becomes difficult to ensure smoothness of the film. Further, the intermediate layer is prevented from becoming too thick, so that the intermediate layer does not peel off easily. The thickness of the intermediate layer varies depending on the qualities of materials, but in many of cases for practical purposes the thickness of the intermediate layer is around 2 to 70 μm.

For the film, a DLC film (diamond like carbon film), a TiN film (titanium nitride film), a TiCN film, a CrN film, a TiC film, an Al₂O₃ film, a Cr₂O₃ film, an SiO₃ film, a Ti₂O₃ film, an AlN film, a ZrN film, an SiC film, etc. are preferably employed. However, any abrasion-resistant film may be used without special limitation. A method for producing the film may be an ion plating method, a plating method, or the like and is not especially limited to a specific method.

When the intermediate layer is formed by means of a diffusion process on the surface of the base material, the intermediate layer is formed by reforming the surface of the base material by means of an ion nitrifying process or the like. Thus, since the intermediate layer is formed integrally with the base material, it is extremely difficult fur the intermediate layer to be separated from the base material. A material for the intermediate layer is not especially limited to a specific material.

Further, the material of the intermediate layer is preferably selected in a manner described below. That is, the coefficient of thermal expansion of the intermediate layer should be lower than a coefficient of thermal expansion of the base material but higher than a coefficient of thermal expansion of the film, or, alternatively, higher than the coefficient of thermal expansion of the base material and lower than the coefficient of thermal expansion of the film. Thus, even when the temperature of the rod changes and as a result thermal stress is generated on the film due to the difference in coefficient of thermal expansion between the base material and the film, the intermediate layer acts as a tempering influence on the thermal stress. Accordingly, the thermal stress generated on the film can be reduced, and even when the temperature of the rod changes while the film is being formed, or either a shearing stress or normal stress is exerted on the surface of the rod while it is being used, it is difficult for cracks or peeling-off to develop on the film.

A plurality of intermediate layers may be formed. Thus, when the thickness of the intermediate layer has a prescribed thickness or greater, it is rarer for chipping to occur on the intermediate layer than in a case in which a single intermediate layer is formed. Moreover, in this case, the materials of the layers are each selected in the following way. That is, starting from the base material side the coefficients of thermal expansion of the layers respectively forming the intermediate layer sequentially become larger in the direction of the film side, or alternatively, they sequentially become smaller starting from the base material side in the direction of the film side. Consequently, even when the difference in coefficient of thermal expansion between the base material and the film is large, it is possible to prevent large-scale thermal stress from occurring on the film.

As described above, according to the first aspect of the invention, since a diffusion layer is formed as a intermediate layer by performing a diffusion process on the surface of the base material, the intermediate layer becomes an integral part of the base material. Accordingly, the intermediate layer is firmly fixed to the base material and it is extremely difficult for the intermediate layer to be separated from the base material.

According to a second aspect of the invention, the surface of the intermediate layer and the surface of the film undergo a lapping process.

The type of lapping process on the surface of the intermediate layer and the surface of the film is not especially limited to one specific type.

According to the present aspect, since the surface of the intermediate layer undergoes the lapping process mentioned above, even when unevenness in rolling occurs on the base material, this unevenness in rolling can be eliminated by the lapping process. Further, when a rod for a coating machine is used, it is possible to prevent force from being excessively exerted on a specific part of the surface of a base material object on which the coating solution is applied, whereby generation of stripe shaped flaws are avoided. In addition, it is possible to remove irregularities, such as micro protruding and recessed parts whose heights may vary, on the surface of the intermediate layer. Accordingly, it is possible to prevent micro protruding and recessed parts whose heights may vary, on the intermediate layer, from producing adverse effects on the surface of the film.

Further, since the surface of the film undergoes a lapping process, even when protruding and recessed parts, or irregularities, are formed on the film during the forming of the film, the protruding and recessed parts can be removed. Thus, when a rod for a coating machine is used, flaws are prevented from occurring on the surface of the base material object on which the coating solution is applied.

In accordance with the second aspect of the invention, the surfaces of the intermediate layer and the film are subjected to a lapping process. In this case, the intermediate layer does not necessarily need to be a reformed type of layer produced by reforming the surface of the base material by means an ion nitrifying process or the like. In other words, an intermediate layer may be formed by plating an ordinary film made of Ni, Cr, W, Co, etc.

Otherwise, an ion nitride layer, a hard chromium layer or a non-electrolytic nickel layer may be employed as an intermediate layer.

In short, in the rod for a coating machine according to the present aspect of the invention, any one of a plating film, an ion plating film or a film reformed by means of an ion nitrifying process may be used as an intermediate layer. Materials thereof and production methods therefor need not be especially limited to specific materials nor to specific methods.

According to a third aspect of the invention, the thickness of the intermediate layer is located within a range of 3 μm to 60 μm.

Thus, the smoothness of the diffusion layer can be satisfactorily ensured and it is possible to prevent the intermediate layer from being excessively thick and thus causing difficulties.

According to a fourth aspect of the invention, the film is an ion plating film formed by an ion plating method. Since the hardness of an ion plating film is relatively high, a rod for a coating machine superior with high abrasion resistance can be achieved.

When the film is the ion plating film as in the case of the rod for a coating machine according to the fourth aspect of the invention, the intermediate layer may be a plating film or an ion plating film. The types of film or production methods therefor are not especially limited to specific materials or to specific production methods. When a layer having a high degree of hardness is formed as an intermediate layer, it is desirable to consider a thickness of intermediate layer such that chipping does not occur. In practice, when the intermediate layer is made of plating film, the thickness of the intermediate layer is generally in a range of 3 to 12 μm. When the intermediate layer is made of ion plating film, thickness of the intermediate layer is generally in a range of 0.2 to 5 μm.

According to the fourth aspect of the present invention, it is possible to obtain a rod for a coating machine having on its surface a film with a high degree of hardness and for which it is difficult to be separated from the base material.

Further, when the surface of the intermediate layer undergoes a lapping process in accordance with the second aspect described above, a rod for a coating machine can at the same time obtain advantageous effects therefrom.

In the rod for a coating machine according to the first to fourth aspects of the present invention, the materials of the layers are respectively selected so that the coefficients of thermal expansion of the layers are sequentially gradually increased starting from the base material side in the direction of the film side, or, alternatively, sequentially gradually decreased starting from the base material side in the direction of the film side. Thus, even when the difference in coefficient of thermal expansion between the base material and the film is large, stress exerted on the film can be tempered, and accordingly, it becomes difficult for cracks to occur on the film.

According to a fifth aspect of the invention, the thickness of the film is located within a range of 0.2 to 5 μm. When the thickness of the film is less than 0.2 μm, the thickness is not adequate for the film to avoid abrasion as described above, and in addition it becomes difficult to ensure the smoothness of the film. Further, since the degree of hardness of ion plating film is generally higher than that of films formed by other methods, when the thickness of the ion-plating film is more than 5 μm, chipping tends to occur on the film. By setting the thickness of the film at 5 μm or less, the occurrence of chipping on the film can be easily prevented.

When a hard chromium film is formed as the film by a wet plating method, the hardness of the surface of the film after the lapping process is about 800 Hv and does not reach 1000 Hv. On the other hand, taking into account the abrasion resistance of the film the surface hardness of the film after the lapping process is preferably 1000 Hv or higher.

Thus, the Vickers' hardness of the film is preferably 1000 Hv or higher. In these circumstances, a rod for a coating machine is achieved in which abrasion resistance of the surface is sufficiently high. For instance, when the material of the film is TiN or DLC (diamond like carbon) or the like, the surface hardness of the film after the lapping process can reach 1000 Hv or higher.

Further more, the Vickers' hardness of the film is more preferably in a range of 1000 Hv to 2000 Hv and the thickness of the film is in a range of 0.2 μm to 3.0 μm.

When the Vickers' hardness of the film is higher than 2000 Hv, residual stress generated on the surface of the film is increased. Consequently, what is called brittleness is apt to appear in the film, just like in a case in which the thickness of the film is increased, and chipping such as cracks and peeling-off tends to occur. On the other hand, when the Vickers' hardness of the film is lower than 1000 Hv, a sufficient abrasion resistance of the film cannot be obtained.

The Vickers' hardness of the film is particularly preferably in a range of 1000 to 1800 Hv and the thickness of the film in a range of 0.2 to 2 μm. With such a film, durability (toughness) of the film can be easily secured.

According to a sixth aspect of the present invention, grooves for regulating a quantity of coating solution are formed on the surface of the base material. By such means, a rod for a coating machine with good durability is achieved, in which the coating solution can be applied after the quantity of coating solution has been appropriately regulated.

According to a seventh aspect of the invention, the radiuses of curvature of angular parts of top parts formed by the grooves are respectively 10 μm or more. By such means, it becomes difficult for the film to be separated at the angular parts of the top parts and easy to prevent stripe shaped scratches from occurring on the surface of the base material to which the coating solution is applied. The present aspect described above exhibits specially excellent effects when an ion plating film having a high degree of hardness is formed as the film.

According to an eighth aspect of the invention, a method for producing a rod for a coating machine comprises step of forming as an intermediate layer on the surface of a cylindrical base material a diffusion layer obtained by reforming the surface of the base material in accordance with a diffusion process; step of lapping the surface of the intermediate layer; step of forming an abrasion-resistant film on the surface of the intermediate layer and step of lapping an uppermost surface of the film.

In such a way, the intermediate layer (diffusion layer) is subjected to a lapping process. Thus, even when unevenness in rolling occurs on the base material, the unevenness in rolling can be easily eliminated. Further, since the intermediate layer is firmly fixed to the base material as described above and it is difficult for the intermediate layer to be separated from the base material during the lapping process, the lapping process can be carried out remarkably easily. Further, it is possible to remove irregularities such as the micro protruding and recessed parts whose height may vary, on the surface of the intermediate layer. Accordingly, it is possible to prevent micro protruding and recessed parts whose heights may vary, on the surface of the intermediate layer from producing adverse effects on the surface of the film.

A desired value of grinding depth in the lapping process varies depending on the method used for forming the intermediate layer and the film (a surface reforming process or the like), and is generally in a range of 0.2 μm to 5 μm. The lapping method is not especially limited to one specific method.

According to a ninth aspect of the invention, the intermediate layer and the film are formed under temperature conditions of 600° C. or lower.

Accordingly, since the intermediate layer and the film are formed at a low temperature, it is possible to reduce residual stress generated on the intermediate layer and the film due to differences in coefficient of thermal expansion between the base material and both the intermediate layer and the film. Therefore, the occurrence of cracks and peeling-off on the film resulting from residual stress can be easily prevented.

According to a tenth aspect of the invention, the film forming process adopted is an ion plating method. Thus, the film can be formed at a low temperature and a film of high abrasion resistance can be formed.

According to an eleventh aspect of the invention, the intermediate layer forming step and the intermediate layer lapping step are alternately carried out a plurality of times.

By these means, when an intermediate layer having a prescribed thickness is formed, chipping on the intermediate layer occurs less frequently than in a case in which an intermediate layer composed of a single layer is formed. Moreover, the materials of layers respectively forming the intermediate layer are selected in the following manner. That is, the coefficients of thermal expansion of the layers respectively forming the intermediate layer are sequentially gradually increased, starting from the base material side in the direction of the film side, or, alternatively, sequentially gradually decreased starting from the base material side in the direction of the film side. Consequently, even when the difference in coefficient of thermal expansion between the base material and the film is large, generation of large scale thermal stress on the film can be avoided.

The surface of the base material may be subjected to a lapping process in advance. In this manner it is possible to eliminate the adverse effects of the protruding and recessed parts whose heights may vary, on the surface of the base material.

According to a twelfth aspect of the invention, the intermediate layer is lapped by means of a lapping process until a maximum surface roughness of the intermediate layer reaches 0.2 μm, and in the lapping process of the uppermost surface, the surface of the film is lapped until the maximum surface roughness of the film reaches 0.2 μm.

In consequence, flaws are satisfactorily prevented from occurring on the base material object. A maximum surface roughness of the intermediate layer and the film is preferably 0.1 μm or less. Thus, it is possible to reliably prevent the occurrence of scratches liable to develop during the initial stages after a rod for a coating machine has been put into use.

According to a thirteenth aspect of the invention, grooves for regulating a quantity of coating solution are formed on the surface of the base material. Thus, it is possible to manufacture a rod for a coating machine with good durability, in use of which rod an coating solution is applied only after a quantity of coating solution has been appropriately regulated.

Here, the inventor of the invention analyzed the state of the surface of the rod for a coating machine, which rod includes a surface of the base material on which grooves were formed for regulating the quantity of coating solution. As a result, the inventor discovered that there had been created wavy variations in the highest points of top parts forming the grooves, mainly owing to unevenness in rolling. A detailed explanation of the above is given with reference to a drawing. As shown in FIG. 24, a height d at the highest points of top parts 589 forming grooves 588 of a base material 582, is at most about 1 μm. Therefore, the inventor discovered the facts described below. That is, when a rod for a coating machine in which the base material 582 was subjected to a surface reforming process was used, the highest points of the top parts abutted, with a strong pressing force, on limited parts of the surface of a base material object to which the coating solution was applied. As a result, stripe-shaped scratches occurred on the surface to which the coating solution was applied.

Consequently, the surface of the base material is preferably lapped until the height at the highest points of the top parts forming the grooves reaches 0.5 μm or less.

Thus, even when there are variations in the height at the highest points of the top parts, such variations can be satisfactorily eliminated. Accordingly, a force is prevented from being excessively exerted on the specific parts of the surface of the base material object on which the coating solution is applied, whereby the occurrence of stripe shaped scratches thereon is avoided. In these circumstances, the thickness of the intermediate layer is preferably adjusted so that the protruding and recessed parts formed by the grooves of the base material are not excessively gentle.

### BRIEF DESCRIPTION OF THE DRAWINGS

FIG. 1 is a side sectional view showing a state in which a coating solution is applied to a web by using a rod for a coating machine according to a first embodiment of the present invention.

FIG. 2 is a partly enlarged side sectional view of the rod for the coating machine according to the first embodiment.

FIG. 3 is a side sectional view showing a state in which a coating solution is applied to a web by using a rod for a coating machine according to a second embodiment of the invention.

FIG. 4 is a partly enlarged side sectional view showing a base material on which grooves are formed in advance in the second embodiment.

FIG. 5 is a partly enlarged side sectional view showing a state in which an intermediate layer is formed on the base material.

FIG. 6 is a partly enlarged side sectional view showing a state in which the surface of the intermediate layer is lapped.

FIG. 7 is a partly enlarged side sectional view showing a state in which a film is formed on the intermediate layer.

FIG. 8 is a partly enlarged side sectional view showing a state in which the surface of the film is lapped.

FIG. 9 is a partly enlarged side sectional view showing a state in which the surface of a web to which a coating solution is applied abuts on the rod for the coating machine according to the second embodiment.

FIG. 10 is a graph showing results of experiments in Example 3.

FIG. 11 is a side sectional view showing a state in which a coating solution is applied to a web by using a rod for a coating machine according to a third embodiment of the invention.

FIG. 12 is a partly enlarged side sectional view showing the structure of the rod for the coating machine according to the third embodiment.

FIGS. 13A to 13C are respectively enlarged views showing states of the surfaces of rods (that is, good states in which chipping does not occur on the surface of the rod) after coating experiments have been carried out using the rod for a coating machine of the present invention in Example 4 (Example 4 is one of the examples which demonstrate the third embodiment).

FIGS. 14A to 14C are respectively enlarged views showing states of the surfaces of the rods (that is, bad states in which chipping occurs on the surface of the rod) after coating experiments have been carried out using a conventional rod for a coating machine in Example 4 (Examples 4 is one of the examples which demonstrate the third embodiment).

FIG. 15 is a graph diagram showing results of experiments obtained by performing coating experiments using an R type rod in Example 4 (Example 4 is one of the examples which demonstrate the third embodiment).

FIG. 16 is a partly enlarged side sectional view showing the structure of a rod for a coating machine according to a fourth embodiment of the invention.

FIG. 17 is a side sectional view showing a state in which a rod for a coating machine produced in a fifth embodiment of the invention is used.

FIG. 18 is a perspective view showing the structure of a chamber of an ion plating device used in the production of a rod for a coating machine in the fifth embodiment of the invention.

FIG. 19 is a schematic side view showing positional relations between the rod and ion sources in the ion plating device used in the production of a rod for a coating machine in the fifth embodiment of the invention.

FIG. 20 is a partial, side sectional view of a base material used in the production of a rod for a coating machine according to the fifth embodiment.

FIG. 21 is a perspective view showing dummy base materials and silicon wafers provided in the chamber when an experiment was carried out in Example 7.

FIG. 22 is a graph diagram showing the results of the measurement of film thickness distribution of the rods obtained in Example 7.

FIG. 23 is a side sectional view showing an example in which a rod for a coating machine is employed as a rod of a type which scraps out the surplus part of a coating solution applied to a web.

FIG. 24 is a partly enlarged side sectional view showing a base material of a conventional rod for a coating machine in which grooves are formed in advance.

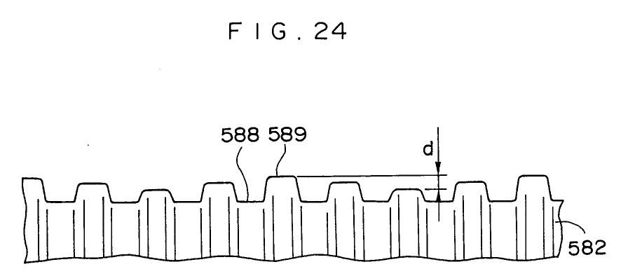

### DETAILED DESCRIPTION OF THE INVENTION

Now, embodiments of the present invention will be described below. For the purpose of simplicity in the embodiments of the invention, a rod for a coating machine will be called simply a rod.

[First Embodiment]

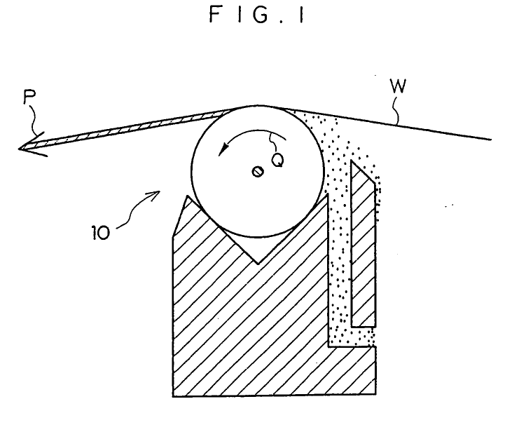

As shown in FIG. 1, a rod 10 for a coating machine (referred to hereinafter simply as a rod 10) according to a first embodiment of the invention is a rod that serves to apply coating solution to a travelling web W and at the same time to regulate a quantity of the coating solution.

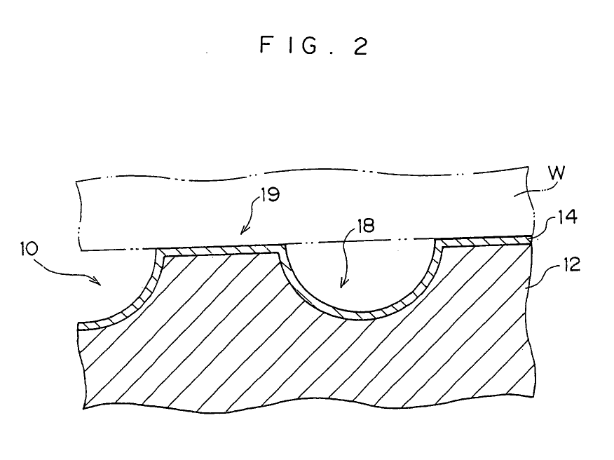

As shown in FIG. 2, on the rod 10, an abrasion-resistant film 14 is formed on a base material 12 having a surface on which grooves 18 are formed for regulating the quantity of coating solution. A plurality of grooves 18 are formed in a circumferential direction of the surface of the base material 12 (that is, in a direction perpendicular to an axial direction and extending along the travelling direction of the web W). The base material 12 is generally made of stainless steel.

To produce the rod 10, bottoms and tops are initially alternately formed in a circumferential direction (that is, a direction perpendicular to the axial direction and extending along the travelling direction of the web W) on the surface of a cylindrical member. As a result, the base material 12 having many grooves 18 formed thereon is formed.

When the grooves 18 are formed by rolling, the height at the highest points of the top parts 19 after the film 14 is formed is desirably set at 0.5 μm or less by lapping. Accordingly, unevenness in rolling occurring when the grooves 18 are formed can be eliminated. In this case, the amount of the film 14 to be formed is regulated in advance, such that the thickness of the film 14 after the lapping process remains sufficient.

Next, the film 14 is formed on the surface of the base material 12. When the film is formed by an ion plating device, the film can be formed at a relatively low temperature. Thus, the difference in temperature of the rod between the time that the film is formed and a time when left in the room temperature is reduced, and it is difficult for cracks or peeling-off to occur on the film 14.

Further, the surface of the film 14 undergoes a lapping process. In this way, even when protruding and recessed parts, or irregularities, are formed on the surface of the film 14 after the film is formed, the protruding and recessed parts are removed by the lapping process. Accordingly, flaws do not occur on the surface of the web W to which the coating solution is applied when the rod 10 is used.

### EXAMPLE 1

As the base material 12 described above, a base material made of stainless steel and having a diameter of 10 mm was used, and a film 14 was formed on the surface thereof. At that time, the type of material of the film 14, the thickness of the film, and whether or not the lapping process was performed were changed as parameters. The list of rods produced is shown in Table 1.

TABLE 1

| | | | | | Maximum | | |
|---|---|---|---|---|---|---|---|
| | Surface | Grindstone | | | surface | Width of wavy parts | State of surface to |
| | reforming | roughness | Thickness | Amount of | roughness Rmax | at the highest points | which coating solution is |
| No. | process | [μm] | of film [μm] | lapping [μm] | [μm] | [μm] | applied (scratches) |
| 1 | Hard Cr | — | 10 | Nil | 0.5 | 0.6 | x |
| 2 | Hard Cr | 0.3 | 10 | 0.5 | 0.2 | 0.4 | ∘ |
| 3 | Hard Cr | 0.3 | 10 | 1 | 0.2 | 0.4 | ∘ |
| 4 | TiN | — | 2 | Nil | 0.5 | 0.6 | x |
| 5 | TiN | 0.3 | 2 | 0.1 | 0.3 | 0.6 | Δ |
| 6 | TiN | 0.3 | 2 | 0.2 | 0.2 | 0.5 | ∘ |
| 7 | DLC | — | 2 | Nil | 0.5 | 0.6 | x |
| 8 | DLC | 0.3 | 2 | 0.1 | 0.3 | 0.5 | Δ |
| 9 | DLC | 0.3 | 2 | 0.2 | 0.2 | 0.4 | ∘ |
| 10 | Hard Cr | 0.3 | 10 | 0.5 | 0.5 | 0.4 | x |
| | | | | (before surface | | | |
| | | | | treatment) | | | |
| 11 | Hard Cr | 0.3 | 10 | 1.0 | 0.5 | 0.4 | x |
| | | | | (before surface | | | |
| | | | | treatment) | | | |
| 12 | Hard Cr | 0.55 | 10 | 0.5 | 0.4 | 0.4 | x |
| 13 | Hard Cr | 0.55 | 10 | 1 | 0.4 | 0.4 | x |

State of the surface of the web to which coating solution is applied:
“∘” represents no scratches,
“Δ” indicates that scratches occurred at several positions within a range of 1 m × 1 m and
“x” indicates that scratches occurred over the entire surface.

Each of the rods thus produced, as set out above, was used to perform an experiment in which a coating solution was applied to a web W travelling at a speed of 70 m/minute. As shown in FIG. 1, the rotating direction Q of the rod is a rotating direction which moves the surface of the rod coming into contact with the web W in the same direction as the travelling direction P of the web.

Then, a post-experimental state of the surface of the web W on which the coating solution had been applied was observed. Results of the experiments are shown in Table 1. In the “state of surface to which coating solution is applied (scratches)” shown in the Table 1, “0” represents no scratches, “Δ” indicates that scratches occurred at several positions within a range of 1 m X 1 m and “X” indicates that scratches occurred over the entire surface, respectively. In Table 1, items having the description of “(before surface treatment)” indicate that the surface of the base material was subjected to a finishing process before the film 14 was formed. Items having no description of “(before surface treatment)” indicate that the surface of the film was subjected to a finishing process after the film 14 was formed.

It is apparent from Table 1 that, when the film 14 was a hard chromium film, and the maximum surface roughness R max was 0.5 μm or 0.4 μm, even when a height at the highest points was 0.4 μm, scratches occurred over the entire surface of the web W to which the coating solution was applied. The phenomenon described above occurred in both the case in which a surface of the base material was subjected to a finishing process before the film 14 was formed, and in the case in which a surface of the film was subjected to the finishing process after the film 14 was formed. Further, it was discovered that when the maximum surface roughness R max was 0.2 μm, even when the hard chromium film was used, it was perfectly possible to prevent scratches from occurring on the surface of the web W to which the coating solution was applied (in this case, the height at the highest points of the top parts was 0.4 μm).

Further, it was discovered that whether the film 14 was a TiN film or a DLC film, when the maximum surface roughness R max was 0.5 μm, scratches occurred over the entire surface of the web W to which the coating solution was applied (in both of these cases, the height at the highest points was 0.6 μm). It was observed that when the R max was 0.3 μm, an effect of this was that the occurrence of some scratches was prevented. Then, as is apparent from the Table 1, when the R max was 0.2 μm, it was possible to prevent completely the occurrences of scratches on the surface of the web W to which the coating solution was applied.

Accordingly, in the present Example, it is concluded that a maximum surface roughness R max of the film 14 is preferably less than 0.5 μm, more preferably 0.3 μm or less and most preferably 0.2 μm or less. When the surface of the film is rougher than 0.2 μm, scratches may occur on the surface of the web W to which the coating solution is applied. Further, it is considered difficult to make the amount of lapping on the surface of any one rod uniform, and in consequence unevenness in the diameter of the rod may occur.

This Example shows an example of a lapping process with the use of a grindstone. However, the same effects can also be obtained with a lapping process using either a film or abrasive grains.

[Second Embodiment]

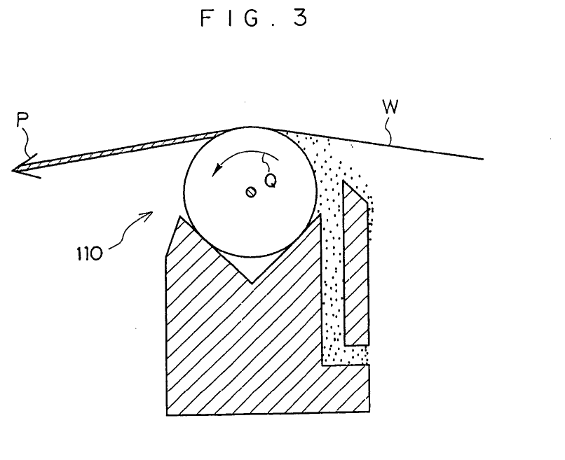

As shown in FIG. 3, a rod 110 according to a second embodiment is a rod which serves to apply coating solution to a running web W and at the same time to regulate a quantity of coating solution.

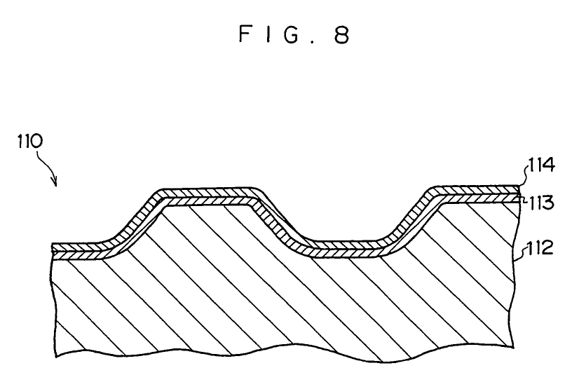

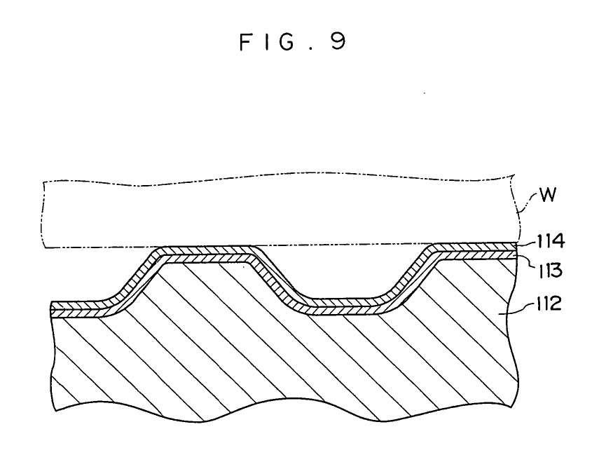

As shown in FIGS. 8 and 9, the rod 110 includes a base material 112, an intermediate layer 113 formed on the base material 112 and an abrasion-resistant film 114 formed on the intermediate layer 113. The base material 112 is generally made of stainless steel.

When the intermediate layer 113 and the film 114 are formed by an ion plating device, the intermediate layer and the film can be formed at relatively low temperatures. Thus, the difference in temperature of the rod between the time that the film is formed and a time when left in the room temperature is reduced. Accordingly, the degree of thermal stress remaining in the intermediate layer 113 or the film due to the difference in coefficient of thermal expansion is reduced, and in consequence cracks or peeling-off rarely occur on either the film 114 or on the intermediate layer 113.

Further, the intermediate layer 113 is a diffusion layer formed by means of a diffusion process on the surface of the base material 112. In this case, since the intermediate layer 113 is formed as an integral part of the base material, it is extremely difficult for the intermediate layer to be separated from the base material.

When materials for the intermediate layer 113 and the film 114 are selected, they are selected in such a manner that coefficients of thermal expansion of the base material 112, the intermediate layer 113 and the film 114 are respectively sequentially increased or, alternatively, sequentially decreased. Thus, even when the temperature of the rod changes and thermal stress occurs on the film 114 due to the difference in coefficient of thermal expansion between the base material 112 and the film 114, the intermediate layer 113 acts as a tempering material, and in consequence, thermal stress occurring in the film 114 is small.

Further, for instance, even when a ceramic of a high degree of hardness, in which chips tend to occur when the thickness of the film is increased, is used to form the film 114, since the intermediate layer 113 has been formed, thickness can be secured starting from the film 114 as far as the base material 112, and, an amount of abrasion can also be avoided.

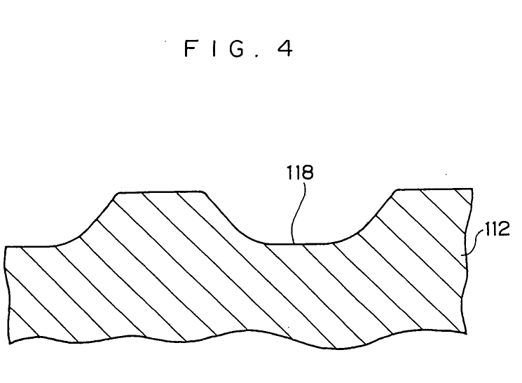

To produce the rod 110, as shown in FIG. 4, a base material 112 is firstly produced on which many grooves 118 are formed. The grooves are formed by alternately forming bottoms and tops on the surface of a cylindrical member in a circumferential direction (that is, a direction perpendicular to an axial direction and extending along the travelling direction of the web W).

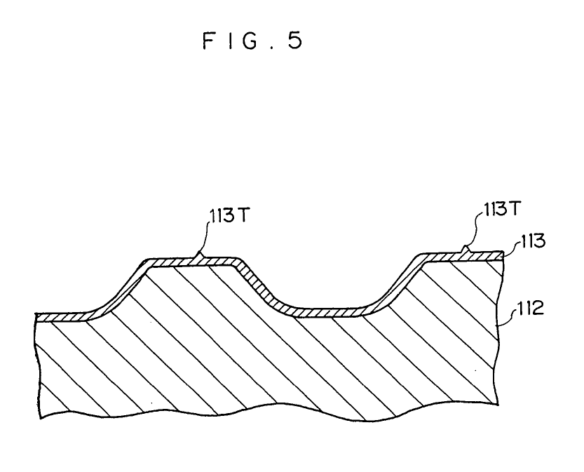

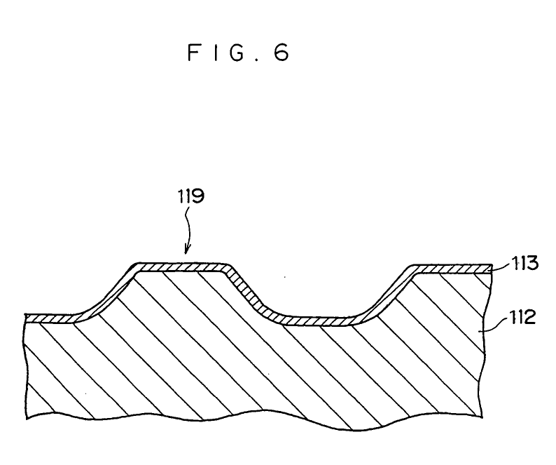

Then, the intermediate layer 113 is formed (see FIG. 5) on the surface of the base material 112 and the surface of the intermediate layer 113 is lapped (see FIG. 6).

When the grooves 118 described above are formed by rolling, the height at the highest points of the top parts 119 after the film 114 has been formed is desirably set by a lapping process at 0.5 μm or less. Thus, unevenness in rolling occurring when grooves 118 are formed can be eliminated. Further, in this case, the amount of intermediate layer 113 to be formed can be regulated in advance, so long as the thickness of the intermediate layer 113 after the lapping process is not insufficient.

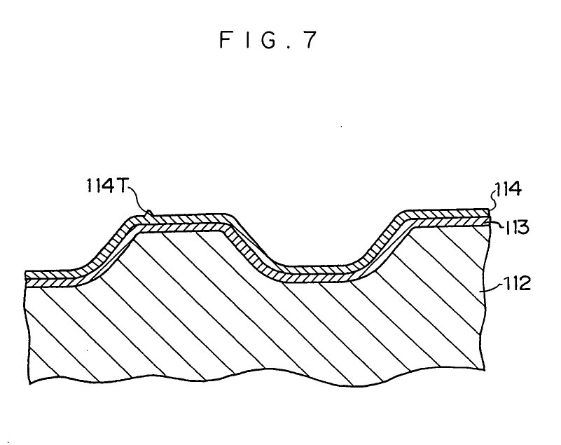

Further, the film 114 is formed (see FIG. 7) the surface of the film 114 is lapped, and the rod 110 is thereby obtained (see FIG. 8).

As described above, in the rod 110 according to the second embodiment, the intermediate layer 113 is provided between the base material 112 and the film 114 and the surface of the intermediate layer 113 is lapped. Thereafter, the film 114 is formed and the surface of the film 114 is further lapped.

Accordingly, even when protruding parts 113T (see FIG. 5) are formed on the surface of the intermediate layer 113, the protruding parts 113T are removed by lapping the surface of the intermediate layer 113. Thus, with one simple process the adverse influence of the protruding parts 113T on the intermediate layer 113 can be prevented from appearing on the film 114. As a result, flaws due to the protruding parts 113T can be prevented from occurring on the surface of the web W to which the coating solution is applied.

Further, even when protruding parts 114T are formed on the surface of the film 114, the surface of the film 114 undergoes a lapping process and protruding parts 114T are removed. Thus, flaws due to the protruding parts 114T are prevented from occurring on the surface of a base material object (member object) to which the coating solution is applied.

Further, since the intermediate layer 113 is formed, even if the intermediate layer is coated with a film 114 with a high degree of hardness, it is difficult for chipping to occur on the film 114. Therefore, the life span of the rod is lengthened, and the number of rods used is reduced, and in consequence costs can be significantly reduced, frequency of changes of the rods is decreased and the operation rate of a production line is improved.

A plurality of intermediate layers may be formed. In these circumstances, the surface of the intermediate layer at an uppermost surface side (outermost surface side) is lapped. Accordingly, even when plural intermediate layers are formed, a lapping process need be performed only once to flatten a substrate surface on which the film 114 is formed.

### EXAMPLE 2

As the base material 112 mentioned above, a base material made of stainless steel and having a diameter of 13 mm was used and an intermediate layer 113 was formed by plating on the surface thereof. Further, a film 114 was formed on the surface thereof by an ion plating process. At that time, types of material of the intermediate layer 113 and whether or not a lapping process is performed were changed as parameters. The list of rods produced is shown in Table 2.

TABLE 2

| | | | | | | | State of surface to |
|---|---|---|---|---|---|---|---|
| | Intermediate layer | | | Film | | | which coating |
| | | Thickness of | Amount of | | Thickness of | Amount of | solution is applied |
| No. | Kind of material | film [μm] | lapping | Kind of material | film [μm] | lapping | (scratches) |
| 1 | Cr | 8 | 1 μm | DLC | 2 | 0.2 μm | ∘ |
| 2 | Cr | 8 | Nil | DLC | 2 | 0.2 μm | x |
| 3 | Ni | 8 | 1 μm | DLC | 2 | 0.2 μm | ∘ |
| 4 | Ni | 8 | Nil | DLC | 2 | 0.2 μm | x |
| 5 | Cr | 8 | 1 μm | DLC | 2 | Nil | x |
| 6 | Cr | 8 | Nil | DLC | 2 | Nil | x |
| 7 | Ni | 8 | 1 μm | DLC | 2 | Nil | x |
| 8 | Ni | 8 | Nil | DLC | 2 | Nil | x |
| 9 | Cr | 8 | 1 μm | DLC | 2 | 0.2 μm | Δ |
| | | | before | | | | |
| | | | film was formed | | | | |
| 10 | Ni | 8 | 1 μm | DLC | 2 | 0.2 μm | Δ |
| | | | before | | | | |
| | | | film was formed | | | | |

(scratches: “∘” indicates no scratches,
“Δ” indicates that scratches occurred in several positions and
“x” indicates that scratches occurred over the entire surface)

Then, each of the rods produced as described above was used to perform an experiment in which the coating solution was applied to a web W travelling at a speed of 80 m/minute. As shown in FIG. 3, the rotating direction Q of the rod is a rotating direction which moves the surface of the rod coming into contact with the web W in the same direction as the travelling direction P of the web.

Then, a post-experimental state of the surface of the web W on which the coating solution was applied was observed. Results of the experiments are shown in Table 2. In the “state of surface to which coating solution is applied (scratches)” shown in the Table 2, “O” indicates that no generation of scratches occurred, “Δ” indicates that scratches occurred in several positions within a range of 1 m X 1 m and “X” represents that scratches occurred over the entire surface, respectively.

As is apparent from Table 2, in the case in which both an uppermost surface, that is, the surface of the film 114 and the surface of the intermediate layer were lapped after the intermediate layer was formed, scratches did not occur on the surface of the web to which the coating solution was applied. Further, in the case in which both the uppermost surface, that is, the surface of the film 114 and the surface of the intermediate layer were lapped before the intermediate layer was formed, scratches did occur to a minor degree on the surface of the web to which the coating solution was applied, but, the effects of lapping were also apparent (see Nos. 9 and 10 in Table 2). Under other conditions, scratches occurred over the entire surface of the web to which the coating solution was applied.

As the base material 112 mentioned above, a base material made of stainless steel and having a diameter of 13 mm was used and an ion nitride film was formed as an intermediate layer 113 by a surface reforming process. Further, a film 114 was formed by an ion plating process. At that time, whether or not a lapping process of the intermediate layer 113 or the film 114 was performed and types of material of the film 114 were changed as parameters. The list of the rods produced is shown in Table 3.

TABLE 3

| | | | | | | | State of surface to |
|---|---|---|---|---|---|---|---|
| | Intermediate layer | | | Film | | | which coating |
| | | Thickness of | Amount of | | Thickness of | Amount of | solution is applied |
| No. | Kind of material | film [μm] | lapping | Kind of material | film [μm] | lapping | (scratches) |
| 1 | Ion nitride | 30 | 1 μm | DLC | 2 | 0.2 μm | ∘ |
| 2 | Ion nitride | 30 | Nil | DLC | 2 | 0.2 μm | x |
| 3 | Ion nitride | 30 | 1 μm | TiN | 2 | 0.2 μm | ∘ |
| 4 | Ion nitride | 30 | Nil | TiN | 2 | 0.2 μm | x |
| 5 | Ion nitride | 30 | 1 μm | DLC | 2 | Nil | x |
| 6 | Ion nitride | 30 | Nil | DLC | 2 | Nil | x |
| 7 | Ion nitride | 30 | 1 μm | TiN | 2 | Nil | x |
| 8 | Ion nitride | 30 | Nil | TiN | 2 | Nil | x |
| 9 | Ion nitride | 30 | 1 μm | DLC | 2 | 0.2 μm | Δ |
| | | | before | | | | |
| | | | film was formed | | | | |
| 10 | Ion nitride | 30 | 1 μm | TiN | 2 | 0.2 μm | Δ |
| | | | before | | | | |
| | | | film was formed | | | | |

(scratches: “∘” indicates no scratches,
“Δ” indicates that scratches occurred at several positions and
“x” indicates that scratches occurred the entire surface)

Then, each of the rods produced as described above was used to perform an experiment in which the coating solution was applied to a web W travelling at a speed of 80 m/minute. The rotating direction Q of the rod was a rotating direction which moves the surface of the rod coming into contact with the web W in the same direction as the travelling direction P of the web, as in the experiments with rods shown in Table 2.

Then, a post-experimental state of the surface of the web W on which the coating solution was applied was observed. Results of the experiments are shown in the Table 3. In the “state of surface to which coating solution is applied (scratches)” shown in the Table 3, “O” indicates that no scratches occurred, “Δ” indicates that scratches occurred in several positions within a range of 1 m X 1 m and “X” indicates that scratches occurred over the entire surface, respectively.

As is apparent from Table 3, when both an uppermost surface, that is, the surface of the film 114 and the surface of the intermediate layer were lapped after the intermediate layer was formed, scratches did not occur on the surface of the web to which the coating solution was applied. In addition, when both the uppermost surface, that is, the surface of the film 114 and the surface of the intermediate layer were lapped before the intermediate layer was formed and, scratches did occur to a minor degree on the surface of the web to which the coating solution was applied, but the effects of lapping were also apparent (see Nos. 9 and 10 in Table 3). Under other conditions, scratches occurred over the entire surface of the web to which the coating solution was applied.

### EXAMPLE 3

As the base material 112 mentioned above, a base material made of stainless steel and having a diameter of 13 mm was used to produce a rod for a coating machine having an intermediate layer 113 and a film 114 formed on the surface of the base material. At that time, types of material of the intermediate layer 113 and the thickness of the film were changed as parameters. The list of rods produced is shown in Table 4.

TABLE 4

| | Intermediate layer | | Film | |
|---|---|---|---|---|
| | | Thickness | | Thickness of |
| No. | Kind of material | of film [μm] | Kind of material | film [μm] |
| 1 | Ni | 10 | TiN | 2 |
| 2 | Hard Cr | 10 | TiN | 2 |
| 3 | Ion nitride | 30 | TiN | 2 |
| | (diffusion layer) | | | |

| | | | |
|---|---|---|---|
| 4 | Nil | TiN | 2 |
| 5 | Nil | H—Cr (Hard Cr) | 10 |

| | |
|---|---|
| 6 | No film |

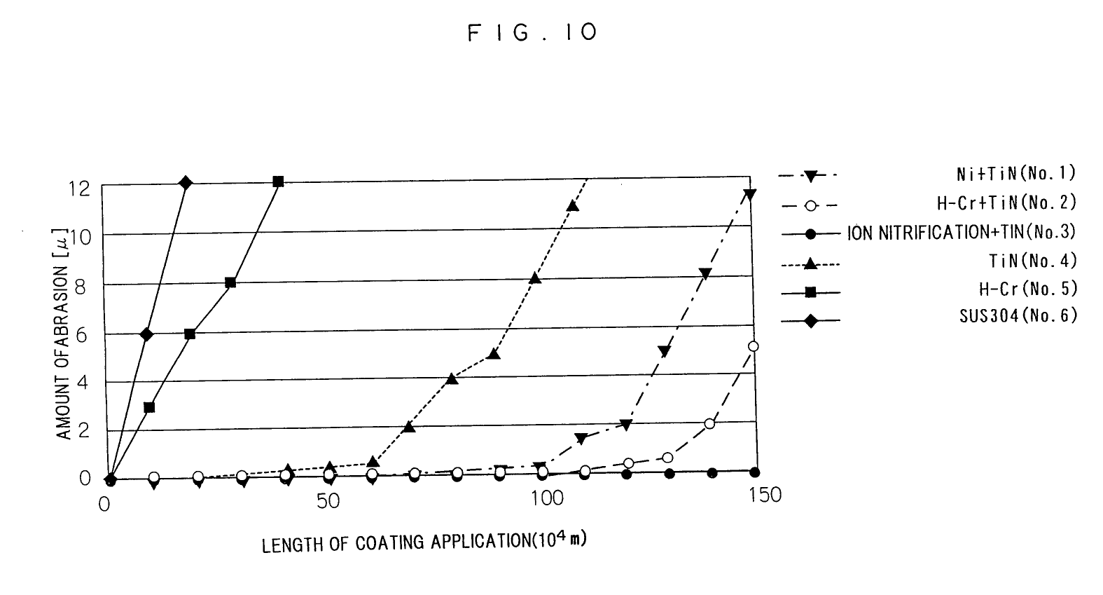

Then, a durability test (abrasion-resistance test) of the rods produced was carried out. Results of the tests are shown in FIG. 10.

Further, rods in which intermediate layers were not formed and the films 114 were formed on the surface of the base materials 112, were produced (see Nos. 4 and 5 in Table 4), and durability tests were likewise carried out on them. Further, durability tests were also carried out for rods made only of the base material without either the intermediate layer or the film being formed (see No. 6 in Table 4). All of the results of the tests are shown in FIG. 10.

Then, each of the rods produced as described above was used to perform an experiment in which an coating solution was applied to a web W travelling at travel speed of 80 m/minute. The rotating direction Q of the rod is a rotating direction which moves the surface of the rod coming into contact with the web W in the same direction as the travelling direction P of the web, as shown in FIG. 3.

As is apparent from Table 4, in each of the rods provided with intermediate layers 113 (Nos. 1 to 3 in Table 4), an amount of abrasion was significantly lower than that of each of the rods having no intermediate layer (Nos. 4 to 6) when coating was effected at the same length of the web. In this way, it was discovered that rods having intermediate layers 113 had extremely high durability from the viewpoint of abrasion resistance.

Further, the rod having a diffusion layer as the intermediate layer 113 (No. 3) had an abrasion resistance several degrees superior to those of the rods in which a diffusion layer was not formed as the intermediate layer 113 (Nos. 1 and 2).

When the rods were not provided with intermediate layers 113 (Nos. 4 and 5), a rod having a film 114 made of a TiN film had a result superior to that of the rod having a film 114 made of a hard Cr film.

[Third Embodiment]

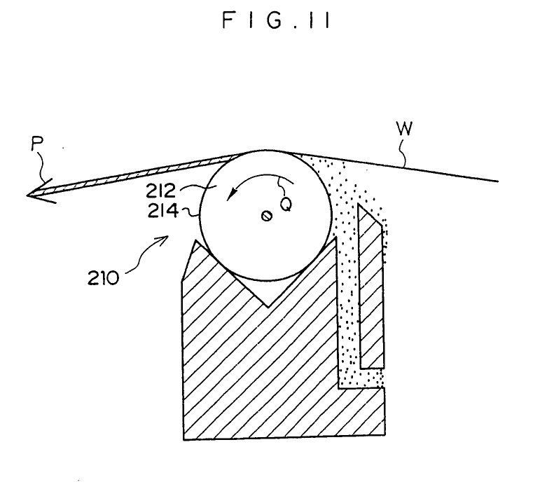

Now, a rod for a coating machine according to a third embodiment of the invention will be described. As shown in FIG. 11, a rod 210 according to the third embodiment of the invention serves both to apply coating solution to a running web W and simultaneously to regulate a quantity of the coating solution.

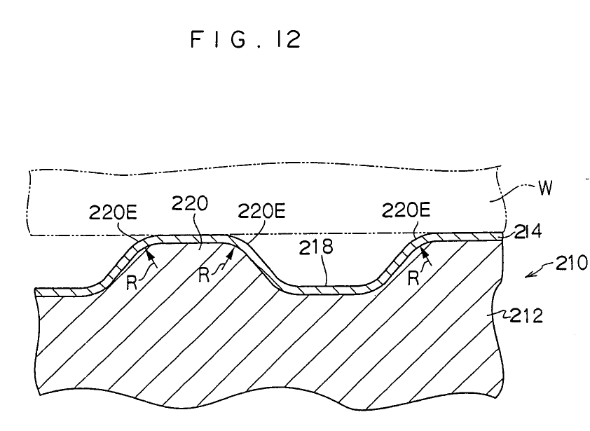

As shown in FIG. 12, the rod 210 has an abrasion-resistant film 214 formed on a base material 212. The base material 212 is generally made of stainless steel. The Vickers' hardness of the film 214 is 2000 Hv and the thickness of the film 214 is 2 μm.

On the surface of the base material 212, many grooves 218 and top parts 220 are alternately formed in a circumferential direction (that is, a direction perpendicular to an axial direction and extending along the travelling direction of a web W). As a result, protruding and recessed parts, or irregularities, are formed on the surface of the rod. Angular parts 220E forming top parts 220 are rounded in R shapes. The radius R of curvature of each of the angular parts 220E is set at 10 μm.

As described above, in the rod 210 according to the third embodiment of the invention, since the angular parts 220E are rounded in R shapes, concentration of stress is avoided on the film 214 formed on the angular parts 220E. Further, since the Vickers' hardness of the film 214 is 2000 Hv and the thickness of the film is 2 μm, it is difficult for chipping to occur on the film in spite that the Vickers' hardness of the film is increased to such a high value.

Accordingly, the degree of cracks and peeling-off occurring on the film 214 during manufacture at the rod 210 is reduced, and in consequence it is possible to improve yield in the manufacture of the rod 210. Further, even when shearing stress or normal stress is exerted on the film by the travelling web W from the upper surfaces of the top parts 220 thereof, cracks and peeling-off rarely occur on the film 214, and in consequence, the possibility of scratches developing on the web W diminishes considerably and productivity of the web W is increased. Further, since the life span of the rod is lengthened and the number of rods used is reduced, costs can be greatly reduced, frequency of changes of rods is decreased and the operation rate of a production line is improved.

When the film 214 is formed by an ion plating device, the film can be formed at a relatively low temperature. Thus, the difference in temperature of the rod between the time that the film is formed and a time when left in the room temperature is reduced, residual thermal stress on the film 214, resulting from the difference in coefficient of thermal expansion, is decreased, and it becomes difficult for cracks or peeling-off to occur on the film 214.

### EXAMPLE 4

As the base material 212, base materials made of stainless steel and having a diameter of 10 mm were used to produce “trapezoidal type” base materials in which the sectional forms of top parts 220 (that is, sectional forms of grooves 218) remained trapezoidal and “R type” base materials in which angular parts 220E of the “trapezoidal type” base material were worked so as to have R shapes (R=10 μm). The grooves 218 were formed by rolling.

Then, as a film 214 a DLC film was formed on each base material by an ion plating method, and eight rods were thus formed. At that time, the Vickers' hardness and the thickness of the film were changed as parameters (see Nos. 1 to 8 in Table 5)

These rods were used to perform an experiment in which, as shown in FIG. 11, a coating solution was applied to a web W travelling at a speed of 60 m/minute These rods served to apply the coating solution to the travelling web W and simultaneously to regulate a quantity of the coating solution. The rotating direction Q of the rod 210 is a rotating direction which moves the surface of the rod coming into contact with the web W in the same direction as the travelling direction P of the web, as shown in FIG. 11. Results of the experiments are shown in Table 5.

TABLE 5

| | | | | | | State of |
|---|---|---|---|---|---|---|
| | | | | | | surface to which |
| | | | | | | coating solution |
| | | | | Thickness of | Surface of rod | is applied |
| No. | Form of groove | Kind of film | Hardness [Hv] | film [μm] | (chipping) | (scratches) |
| 1 | R type | DLC | 2000 | 4 | x | x |
| 2 | Trapezoidal type | DLC | 2000 | 4 | x | x |
| 3 | R type | DLC | 2000 | 2 | ∘ | ∘ |
| 4 | Trapezoidal type | DLC | 2000 | 2 | x | x |
| 5 | R type | DLC | 1500 | 4 | Δ | x |
| 6 | Trapezoidal type | DLC | 1500 | 4 | x | x |
| 7 | R type | DLC | 1500 | 2 | ∘ | ∘ |
| 8 | Trapezoidal type | DLC | 1500 | 2 | x | x |

State of generation of chipping on the surface of rod:
“∘” represents no generation of chipping;
“Δ” represents generation of chipping at several parts throughout the entire length of rod and
“x” represents generation of chipping in many parts, respectively. State of surface of web on which coating solution is applied;
“∘” represents no scratches and
“x” represents generation of scratches, respectively.

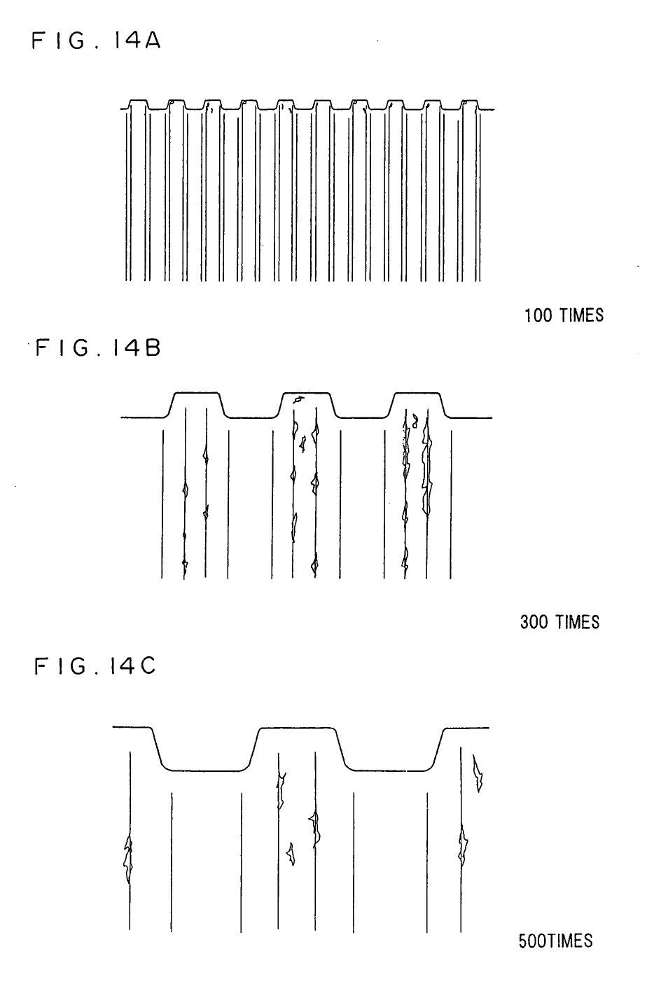

As is apparent from Table 5, when the sectional forms of the grooves 218 of the base materials remained trapezoidal (that is, in the case of the trapezoidal types), every one of four rods in which either the Vickers' hardness of the films 214 or the thickness of the films had been changed exhibited chipping on the film 214 (see FIGS. 14A to 14C). Further, the state of the surface of the web W to which the coating solution was applied was not good (scratches occurred).

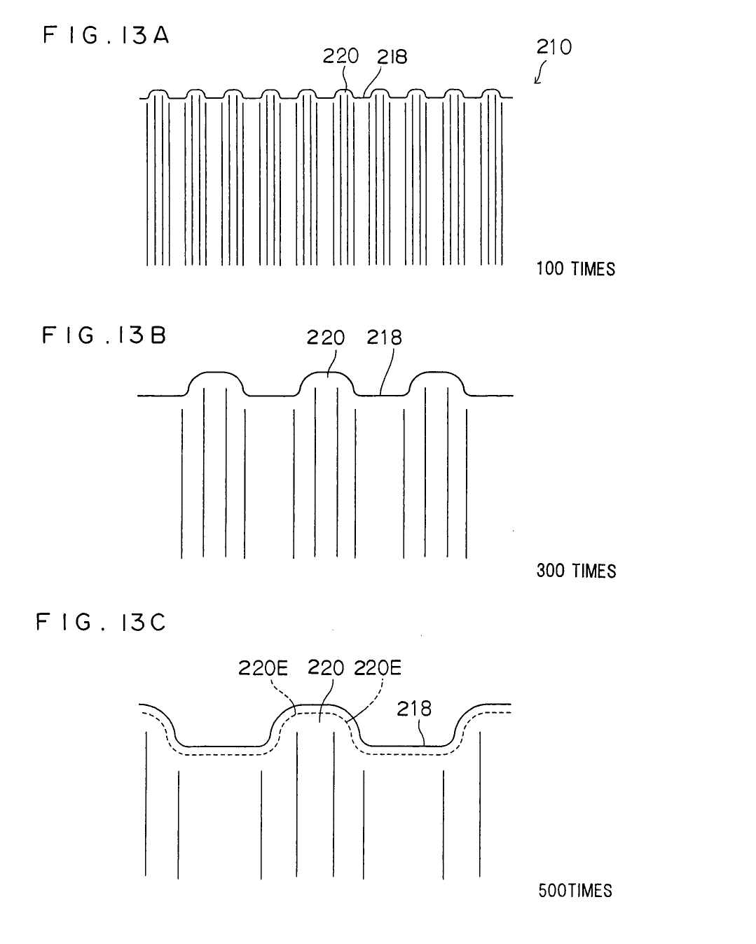

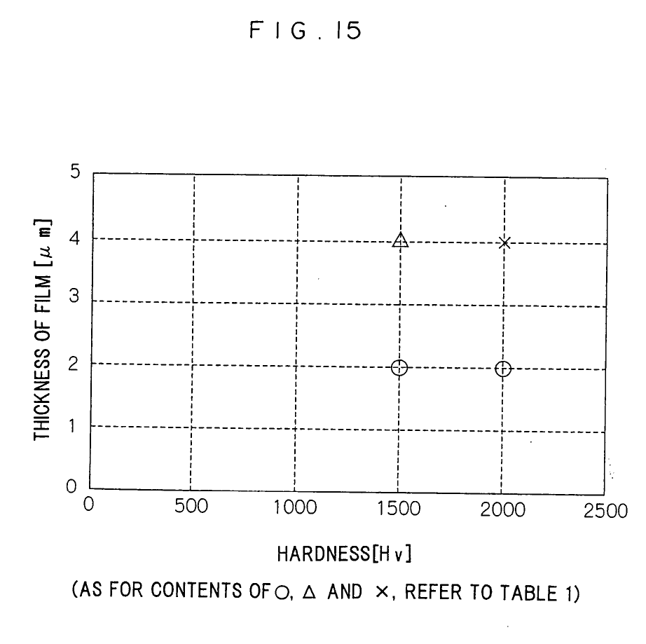

On the other hand, when the angular parts 220E were formed in R shapes (that is, in the case of the R types), out of four rods in which either the Vickers' hardness of the films 214 or the thickness of the films had been changed, two rods (Nos. 3 and 7 in Table 5) in which the thickness of the films 214 was 2 μm exhibited no chipping on the films 214 (see FIG. 13A to FIG. 13C and FIG. 15), and the state of the surface of the web W to which the coating solution was applied was good (a state in which scratches did not occur). FIG. 15 shows the results of the experiments in which the angular parts 220E were formed into R shapes.

### EXAMPLE 5

As the base material 212, base materials made of stainless steel and having a diameter of 10 mm were used to produce respectively two trapezoidal type base materials, in which the sectional forms of top parts 220 (that is, sectional forms of grooves 218) remained trapezoidal, and two R type base materials in which angular parts 220E were worked so as to have R shapes (R=10 μm). The grooves 218 were formed by rolling.

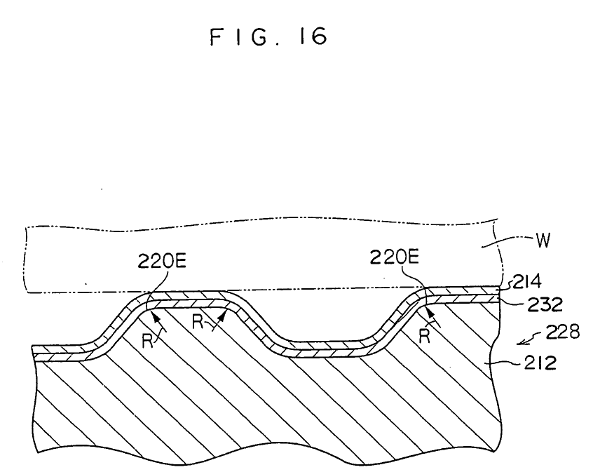

Then, a hard chromium film having a thickness of 10 μm was formed on the surface of each base material as an intermediate layer 232 (see FIG. 16 below). Further, the intermediate layer was lapped to a maximum surface roughness of 0.2 μm or less.

Then, as a film 214 a TiN film was formed by an ion plating method on the surface of one trapezoidal type base material and on the surface of one R type base material respectively. Then, the film 214 was lapped to a maximum surface roughness of 0.2 μm or less.

Further, as a film 214 a DLC film was formed by an ion plating method on the surface of one trapezoidal type base material and on the surface of one R type base material respectively. The list of the rods produced is shown in Table 6.

TABLE 6

| | | | | | | | State of surface to |
|---|---|---|---|---|---|---|---|
| | | Intermediate layer | | Film | | | which coating |
| | | | Thickness of | | Thickness of | Surface of rod | solution is applied |
| No. | Form of groove | Kind of film | film [μm] | Kind of film | film [μm] | (chipping) | (scratches) |
| 1 | R type | Hard Cr | 10 | DLC | 2 | ∘ | ∘ |
| 2 | Trapezoidal | Hard Cr | 10 | DLC | 2 | x | x |
| | type | | | | | | |
| 3 | R type | Hard Cr | 10 | TiN | 2 | ∘ | ∘ |
| 4 | Trapezoidal | Hard Cr | 10 | TiN | 2 | x | x |
| | type | | | | | | |

Occurrence of chipping on the surface of the rod:
“∘”” indicates no occurrence chipping;
“Δ” indicates occurrence of chipping in several positions throughout the entire length of the rod and
“x” represents occurrence of chipping in many parts, respectively. State of surface of web on which coating solution is applied;
“∘” indicates no scratches and
“x” indicates occurrence of scratches, respectively.

These rods were used to perform an experiment in which a coating solution was applied to a web W travelling at a speed of 60 m/minute. The rods were used as rods characterized in that they applied the coating solution to the travelling web W and simultaneously regulate a quantity of the coating solution, as shown in FIG. 11. The rotating direction Q of the rod 210 is a rotating direction which moves the surface of the rod coming into contact with the web W in the same direction as the travelling direction P of the web as shown in FIG. 11. Results of the experiments are shown in Table 6.

As is apparent from Table 6, when the sectional forms of the grooves 218 of the base materials remained trapezoidal (that is, in the case of the trapezoidal types), every one of the rods exhibited chipping on the film 214. Further, the state of the surface of the web W to which the coating solution was applied was not good (scratches occurred).

On the other hand, when the angular parts 220E were formed in to R shapes (that is, in the case of the R types), none of the rods exhibited chipping on the films 214, and the state of the surface of the web W to which the coating solution was applied was good (a state in which scratches did not occur)

[Fourth Embodiment]

Now, a rod for a coating machine according to a fourth embodiment of the invention will be described below. In the fourth embodiment, the same components as those of the third embodiment are designated by the same reference numerals and an explanation thereof is omitted.

As shown in FIG. 16, in a rod 228 according to the fourth embodiment of the invention, an intermediate layer 232 is formed between abase material 212 and a film 214. The material of the intermediate layer 232 is selected in such a manner that coefficients of thermal expansion are sequentially either gradually increased or gradually decreased in order of the base material 212, the intermediate layer 232 and the film 214.

Thus, chipping of the film 214 can be controlled and an amount of abrasion can be avoided, in consequence the yield of the rod 228 can be improved and the life span of the rod can be lengthened.

### EXAMPLE 6

As the base material 212, base materials made of stainless steel and having a diameter of 14 mm were used to produce eight R type base materials in which the sectional forms of grooves 218 were trapezoidal and angular parts 220E were formed into R shapes. The values of radiuses R of curvature of the angular parts 220E were equal to those in Example 4.

Then, on six out of the eight base materials, hard Cr films (coefficient of thermal expansion of 12.5×10⁻⁶/° C.), ion nitride films (coefficient of thermal expansion of 12×10⁻⁶/° C.) or non-electrolytic nickel films (coefficient of thermal expansion of 13.3×10⁻⁶/° C.) were formed as the intermediate layers 232. Further, DLC films (coefficient of thermal expansion of 0.8 to 7.8×10⁻⁶/° C.) were formed as the films 214 and the rods formed. At that time, the Vickers' hardness and the thickness of the films were changed as parameters (see Nos. 1 to 6 in Table 7).

These rods were used to perform an experiment in which a coating solution was applied to a web W travelling at a speed of 80 m/minute. These rods were characterized in that they applied the coating solution to the travelling web W and simultaneously regulated a quantity of the coating solution, as shown in FIG. 11. The rotating direction Q of the rod 228 is a rotating direction which moves the surface of the rod coming into contact with the web W in the same direction as the travelling direction P of the web, as shown in FIG. 11. Results of the experiments are shown in Table 7.

TABLE 7

| | | | | | | | State of surface |
|---|---|---|---|---|---|---|---|
| | Intermediate layer | | Film | | | | to which coating |
| | | Thickness of | Kind of | Thickness of | Hardness | Surface of rod | solution is applied |
| No. | Kind of material | film [μm] | material | film [μm] | [Hv] | (chipping) | (scratches) |
| 1 | Hard Cr | 10 | DLC | 3 | 1800 | ∘ | ∘ |
| | Hard Cr | 10 | DLC | 3 | 1500 | ∘ | ∘ |
| 3 | Ion nitride | 30 | DLC | 3 | 1800 | ∘ | ∘ |
| 4 | Ion nitride | 30 | DLC | 3 | 1500 | ∘ | ∘ |
| 5 | Non-electrolytic Ni | 10 | DLC | 3 | 1800 | ∘ | ∘ |
| 6 | Non-electrolytic Ni | 10 | DLC | 3 | 1500 | ∘ | ∘ |

| | | | | | | |
|---|---|---|---|---|---|---|
| 7 | None | DLC | 3 | 1800 | x | x |
| 8 | None | DLC | 3 | 1500 | Δ | x |

Occurrence of chipping on the surface of the rod:
“∘” indicates no occurrence chipping;
“Δ” represents occurrence of chipping in several positions throughout the entire length of the rod and
“x” represents occurrence of chipping in many parts, respectively. State of surface of web on which coating solution is applied;
“∘” indicates no scratches and
“x” indicates occurrence of scratches, respectively.

As is apparent from Table 7, in the cases of rods (see Nos. 7 and 8 in Table 7) on which intermediate layers 232 had not been formed, chipping occurred on the surfaces of the rods and the state of the surface of the web W to which the coating solution was applied was not good (i.e., a state in which scratches occurred). However, in the cases of rods on which intermediate layers 232 had been formed, chipping did not occur on the surfaces of the rods, and the state of the surface of the web W to which the coating solution was applied was good (i.e., a state in which scratches did not occur).

[Fifth Embodiment]

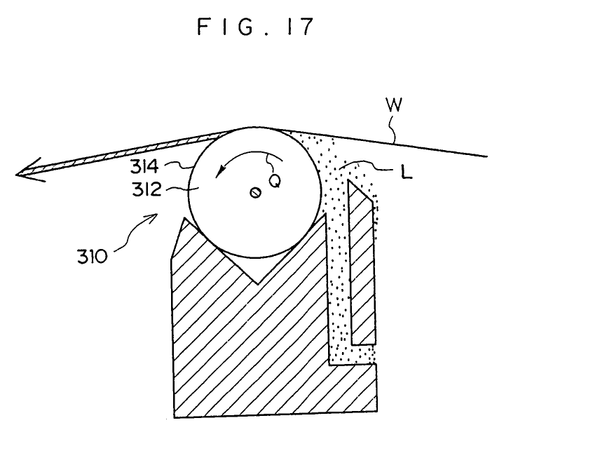

A method for producing a rod for a coating machine according to a fifth embodiment of the invention is a production method for a rod used for applying coating solution L to a travelling web W, as shown in FIG. 17. A rod 310 includes a base material 312 and an abrasion-resistant film 314 formed on the surface of the base material 312. The base material 312 is frequently made of stainless steel. The film 314 is formed by an ion plating device.

[Structure of Ion plating Device]

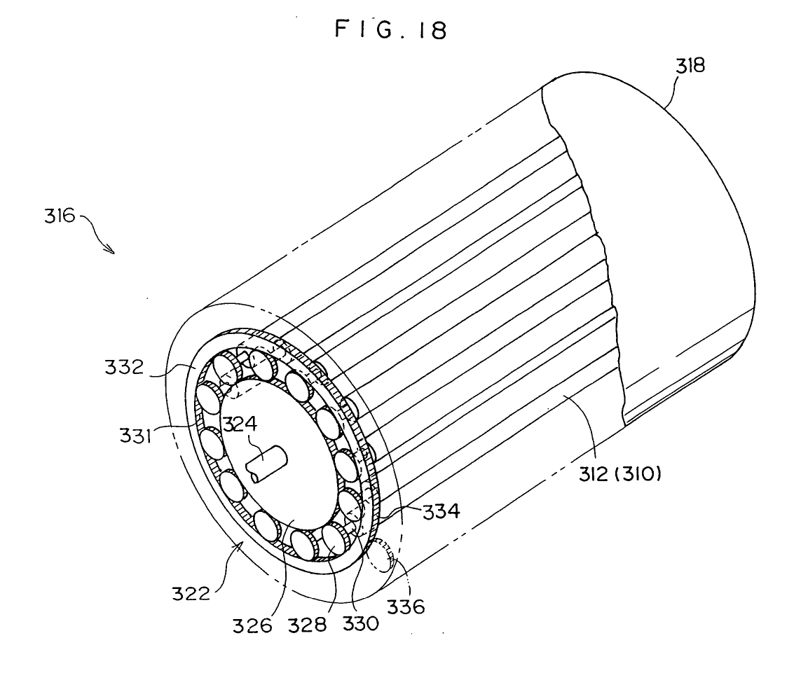

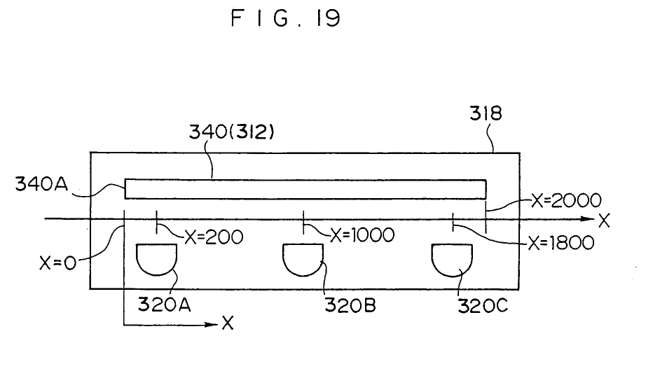

An ion plating device 316 (see FIGS. 18 and 19) for coating a film includes a chamber 318 and three ion sources 320A to 320C (see FIG. 19) provided in the chamber.

As shown in FIG. 18, the chamber 318 is formed with a dimension so as to accommodate therein rods 310 having a prescribed length. Further, the chamber 318 is provided with a holding part 322 for holding a plurality of rods such that the rods are capable of rotating and revolving.

The holding part 322 includes a center shaft 324 and a spur gear 326 fixed to an end part of the center shaft 324. To the other end part of the center shaft 324, a spur gear (not shown) is likewise fixed. Further, the holding part 322 includes a plurality of small spur gears 328 engaging with the spur gear 326 and a ring shaped gear 332 engaging with the small spur gears 328 by way of gear teeth 331 thereof at an inner peripheral side. Each small spur gear 328 has an attaching part 330 for attaching and detaching the rod.

The ring shaped gear 332 has gear teeth 334 formed at an outer peripheral side. In the chamber 318, a driving gear 336 which engages with the gear teeth 334 is provided. The rotation of the driving gear 336 allows the ring shaped gear 332 to rotate, so that the small spur gears 328 rotate, with revolving around the spur gear 326.

In the holding part 322 with the structure described above, the ring shaped gear 332 can rotate and the small spur gears 328 can rotate with revolving, even in a vacuum.

As shown in FIG. 19, the ion source 320A is provided in a position near an inlet of the chamber 318. The ion source 320B is provided in a central position of the chamber 318 and the ion source 320C is provided in an inward position of the chamber 318, respectively. When a rod having a prescribed length is accommodated in the chamber 318, both the end parts of the rod are located near the ion sources 320A and 320C respectively and the central part of the rod is located near the ion source 320B.

[Production of Product by Forming Film on Base Material]

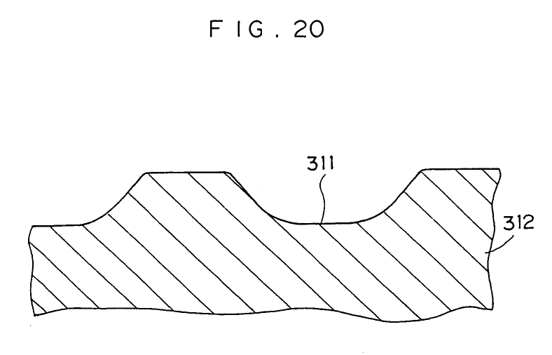

In the present embodiment, a product (rod) on which an abrasion-resistant film is formed is produced by using the ion plating device 316 described above. Initially, each of the unused long cylindrical base materials 312, on which grooves 311 (see FIG. 20) for regulating the volume of coating solution had been formed in advance, is attached to an attaching part 330 at each of the small spur gears 328.

Then, after the vacuum suction of the chamber 318 has been performed, while the small spur gears 328 are rotated and revolved, abrasion-resistant films 314 are formed on the base materials 312 by an ion plating method. At that time, the outputs of the ion sources 320A to 320C are regulated to form the films 314 substantially uniformly to a desired thickness (generally in a range of 0.2 μm to 3.0 μm).

Accordingly, since a rod 310 can be produced such that the thickness of the abrasion-resistant film 314 is uniform, even when the thickness of the film 314 is reduced, there is no possibility of a film portion which is excessively thin in parts being produced. Therefore, when the coating solution is applied to a running web w by means of the rod 310, an area of contact between the rod 310 and the web W is increased and partial wear (unbalanced abrasion) of the rod 310 is thus avoided.

Therefore, even when the coating solution is applied to the web at a high speed, it is possible to prevent incoveniences such as a deterioration in coating or application accuracy, or the occurrence of streaks during application. Further, even when shearing stress or normal stress is exerted on the surface of the rod 310 due to a force applied by the running web W during use of the rod 310, it is difficult for cracks or peeling-off to occur on the film 314. Still further, since the life span of the rod 310 is lengthened, the number of rods 310 used can be reduced, thus contributing substantial savings in costs. Still further, the number of changes of rods 310 is reduced during the use of the rods (that is, during the operation of an application line in which rods 310 are provided) and as a result the operation rate of the production line of the web W can be considerably improved.

Further, the ion plating device 316 having the holding part 322 is used so that films can be formed on plural base materials at the same time to produce rods 310. Accordingly, the number of times that the ion plating device 316 is operated can be reduced and costs can be accordingly reduced. In this case, the distribution of thickness in the films 314 is the same in each of rods and the mass production of the same products can be achieved. Further, even in the case of a rod having grooves formed on its surface, the thickness of the film can be easily measured and the thickness of the film can therefore be easily managed and controlled.

As a material of the film 314, diamond like carbon (DLC) or titanium nitride (TiN) is preferable. Other preferable materials include, TiCN, CrN, TiC, Al₂O₃, Cr₂O₃, SiO₃, Ti₂O₃, AlN, ZrN, SiC, etc.

### EXAMPLE 7

In Example 7, the ion plating device 316 was used and the outputs of the ion sources 320A to 320C were changed as parameters, to measure the thickness distribution of the films formed.

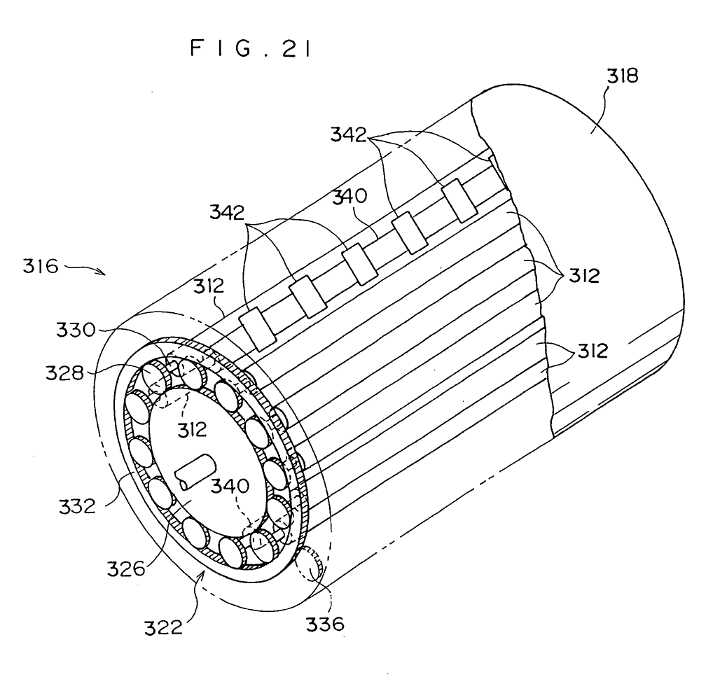

In this experiment, as shown in FIG. 21, in order to measure the distribution of film thickness of the rods in the width direction thereof (that is, a longitudinal direction), two cylindrical dummy base materials 340 (dummy rods) on which grooves had not been formed were attached and a plurality of silicon wafers 342 was stuck on positions where the thickness of the dummy base materials 340 was measured. As the film, a DLC film was formed. The base materials 312 described above were attached at all of the positions except for the positions where the dummy base materials 340 were attached.

The length L of both the base materials 312 and the dummy base materials 340 was 2000 mm. The ion source 320A was located at a position only 200 mm toward the rod central side from the end portion 340A of the base material. The ion source 320C is also located a position only 200 mm toward the rod central side from the end portion 340C of the base material. The ion source 320B is located at the central position of the rod. The above-described matter will be described more specifically with reference to FIG. 19. Starting from the end part of the rod near the inlet of the chamber 318 as the origin, and taking an X axis toward the interior of the chamber, the ion source 320A is located at X=200 mm, the ion source 320B is located at X=1000 mm and the ion source 320C is located at X=1800 mm.

In this experiment, the films were formed under three different film forming conditions (Nos.1 to 3) in which the outputs of the three ion sources 320A to 320C were made different. In No. 1, the outputs of the ion sources 320A to 320C were made equal. In No. 2, the outputs of the ion sources 320A and 320C were set at 100% and the output of the ion source 320B was set at 0%. In No. 3, the outputs of the ion sources 320A and 320C were set to 100% and the output of the ion source 320B was set at 30%.

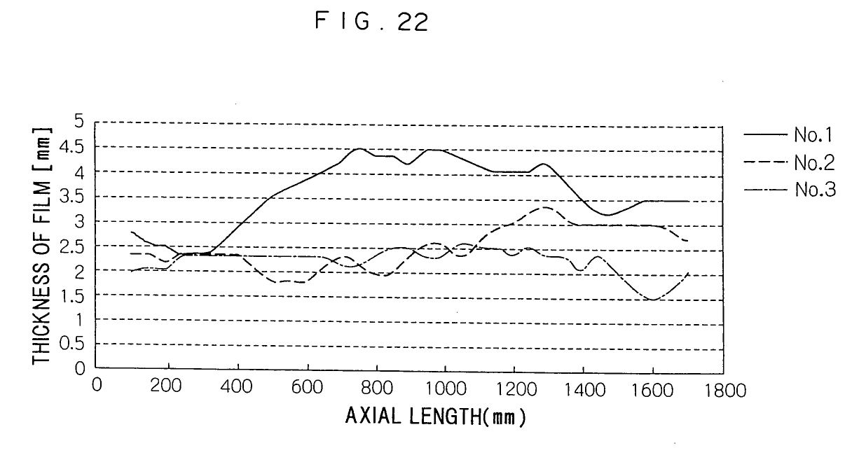

After films were formed in accordance with the conditions Nos. 1 to 3, the thickness of the films formed on the silicon wafers 342 was respectively measured to obtain the film thickness distribution. This film thickness distribution is shown in FIG. 22.

Further, the rods having the films 314 formed on the base materials 312 were used to perform an experiment in which a coating solution was applied on the surface of a web W. The characteristics of the rods obtained in accordance with conditions Nos.1 to 3 and the results of application experiments using the rods are shown in Table 8. In Table 8, to calculate a film thickness distribution range, FIG. 22 was employed.

TABLE 8

| | | | | | | State of surface |
|---|---|---|---|---|---|---|
| | | | Film thickness | Coefficient of | | to which coating |
| | Material of | Thickness of film | distribution range | friction | Hardness | solution is applied |
| No. | film | [μm] | (%) | [−] | [Hv] | (scratches) |
| 1 | DLC | 2.2-4.5 | | 0.1 | 1800 | x |
| 2 | DLC | 1.8-3.2 | ±30% | 0.1 | 1800 | Δ |
| 3 | DLC | 1.5-2.5 | ±25% | 0.1 | 1800 | ∘ |

State of generation of scratches
∘: no occurrence scratches
Δ: occurrence of scratches in several positions
x: occurrence of scratches over the entire surface

As is apparent from Table 8, when application experiments were carried out with rods in which the outputs of the ion sources had been regulated during the production thereof to restrict the film thickness distribution range to within 25% and in addition the thickness of the film 314 was restricted to within a range of 0.2 μm to 3.0 μm (i.e., rods obtained in accordance with No. 3), good results were obtained insofar that scratches did not occur on the surface to which the coating solution was applied. Further, in the cases of rods in which the film thickness distribution range had been restricted to within 30%(i.e., rods obtained in accordance with No. 2), scratches occurred only in several positions within a range of 1 m X 1 m, and in consequence the number of scratches occurring was relatively small. On the other hand, in the cases of the rods in which the film thickness distribution range was 33%(rods obtained in accordance No. 1), scratches occurred over the entire surface to which the coating solution was applied.

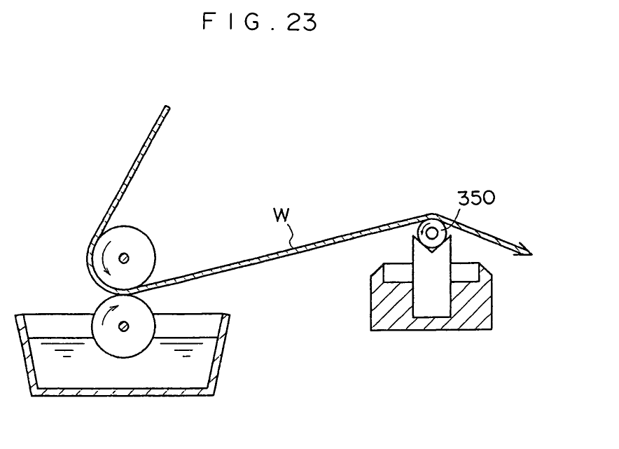

Although the invention has been described by way of the embodiments outlined above, the invention is not limited to the embodiments described above and various kinds of modifications may be made within limits, without departing from the sprit of the invention. For instance, a wire may be wound on the outer peripheral surface of a base material and, while the generation of gas and the like is controlled, a film may be formed on the outer peripheral surface of the wire either by a wet plating method or a dry plating method. In these circumstances, grooves may be formed on the base material so as to fit the diameter of the wire. Further, the film may be effectively formed without grooves being formed on the base material. Moreover, the method described above may be applied to a method for producing a rod 350 (see FIG. 23) of a type for scraping off an excess of coating solution applied to a web W. Furthermore, the embodiments described above may be suitably combined with each other. It goes without saying that a scope of the invention should not be limited to the embodiments described above.

Thus, since the invention has the structure described above, a rod for a coating machine with high durability can be achieved, in use of which rod flaws are prevented from occurring on the surface of a base material object on which a coating solution is applied.

What is claimed is:

1. A rod for a coating machine comprising:
a cylindrical base material;
an intermediate layer formed on a surface of the base material;
an abrasion-resistant film formed on a surface of the intermediate layer,
wherein the intermediate layer is a diffusion layer formed by reforming the surface of the base material by a diffusion process.

2. A rod for a coating machine according to claim 1, wherein the surface of the intermediate layer and a surface of the film undergo a lapping process.

3. A rod for a coating machine according to claim 1, wherein a thickness of the intermediate layer is located within a range of 3 to 60 μm.

4. A rod for a coating machine according to claim 1, wherein the film is an ion plating film formed by an ion plating method.

5. A rod for a coating machine according to claim 4, wherein a thickness of the film is in a range of 0.2 to 5 μm.

6. A rod for a coating machine according to claim 1, wherein a Vickers' hardness of the film is 1000 Hv or more.

7. A rod for a coating machine according to claim 1, wherein grooves for regulating a quantity of coating solution are formed on the surface of the base material.

8. A rod for a coating machine according to claim 7, wherein radiuses of curvature of angular parts of top parts formed by the grooves are respectively 10 μm or more.

9. A rod for a coating machine comprising:
a cylindrical base material;
an intermediate layer formed on a surface of the base material and subjected to a lapping process; and
an abrasion-resistant film formed on a surface of the intermediate layer and subjected to a lapping process.

10. A rod for a coating machine according to claim 9, wherein the intermediate layer includes a plurality of layers and/or the intermediate layer is a diffusion layer formed by reforming the surface of the base material by a diffusion process.

11. A rod for a coating machine according to claim 9, wherein a maximum surface roughness of the film is 0.2 μm or less.

12. A rod for a coating machine according to claim 9, wherein a thickness of the film is 5 μm or less.

13. A rod for a coating machine according to claim 9, wherein a Vickers' hardness of the film is 1000 Hv or more.

14. A rod for a coating machine used for applying coating solution to a base material object that continuously travels, said rod for a coating machine comprising:
a cylindrical base material; and
an abrasion-resistant film formed on a surface of the base material,
wherein a Vickers' hardness of the film is located within a range of 1000 Hv to 2000 Hv and a thickness of the film is in a range of 0.2 μm to 3.0 μm.

15. A rod for a coating machine according to claim 14, wherein grooves are formed on a surface of the base material to form protruding and recessed parts, and radiuses of curvature of angular parts of top parts of the protruding parts is 10 μm or more.

16. A rod for a coating machine according to claim 14, wherein an intermediate layer is provided between the base material and the film and the intermediate layer has a coefficient of thermal expansion which is intermediate between coefficients of thermal expansion of the base material and the film.

17. A rod for a coating machine according to claim 16, wherein one of an ion nitride layer, a hard chromium layer or a non-electrolytic nickel layer is provided as the intermediate layer.

18. A method for producing a rod for a coating machine comprising:
an intermediate layer forming step (a) of forming as an intermediate layer on a surface of a cylindrical base material, a diffusion layer obtained by reforming the surface of the base material by a diffusion process;
an intermediate layer lapping step (b) of lapping a surface of the intermediate layer;
a film forming step (c) of forming an abrasion-resistant film on the surface of the intermediate layer and
an uppermost surface lapping step (d) of lapping a surface of the film.

19. A method for producing a rod for a coating machine according to claim 18, wherein the intermediate layer forming step (a) includes a step for forming the intermediate layer under a condition of temperature of 600° C. or lower, and the film forming step (c) includes a step for forming the film under a condition of temperature of 600° C. or lower.

20. A method for producing a rod for a coating machine according to claim 19, wherein the film is formed by an ion plating method in the film forming step (c).

21. A method for forming a rod for a coating machine according to claim 18, wherein the intermediate layer forming step (a) and the intermediate layer lapping step (b) are alternately carried out a plurality of times.

22. A method for producing a rod for a coating machine according to claim 18, wherein the intermediate layer lapping step (b) includes a step for lapping the intermediate layer until a maximum surface roughness of the intermediate layer reaches 0.2 μm and the uppermost surface lapping step (d) includes a step for lapping the surface of the film until the maximum surface roughness of the film reaches 0.2 μm.

23. A method for producing a rod for a coating machine according to claim 18, further comprising a step of forming grooves in advance for regulating a quantity of coating solution for the surface of the base material.

24. A method for producing a rod for a coating machine according to claim 18, further comprising a step of lapping the surface of the cylindrical base material in advance.

25. A method for producing a rod for a coating machine according to claim 24, further including a step of forming grooves for regulating a quantity of coating solution on the surface of the base material and lapping the surface of the base material until a height at highest points of top parts forming the grooves reaches 0.5 μm or less.
